(19) United States
(12) Patent Application Publication
(10) Pub. No.: US 2005/0214497 A1
(43) Pub. Date: Sep. 29, 2005

(54) Anaerobic activator film and labels made therefrom

(76) Inventor: Wayne Louis Bilodeau, Mentor, OH (US)

Correspondence Address: RENNER, OTTO, BOISSELLE & SKLAP, LLP, 1621 EUCLID AVE, 19TH FL, CLEVELAND, OH, 44115-2191, US

(21) Appl. No.: 11/069,028

(22) Filed: Feb. 28, 2005

Related U.S. Application Data
(60) Provisional application No. 60/557,319, filed on Mar. 29, 2004.

(51) Int. Cl. B32B 33/00

(52) U.S. Cl. 428/41.8; 156/310

(57) ABSTRACT

Films useful for activating anaerobic adhesives and coatings are described, and more particularly, labels are described which comprise (a) a polymer facestock having an upper surface and a lower surface, and (b) an activating layer having an upper surface and a lower surface wherein the upper surface of the activating layer underlies the facestock, and the activating layer comprises at least 1 activating agent for anaerobic curing. There is also described a method of labeling substrates utilizing the labels with anaerobic adhesives.

This application claims the benefit of provisional application Ser. No. 60/557,319 filed on Mar. 29, 2004, which is hereby incorporated herein by reference in its entirety.

### TECHNICAL FIELD OF THE INVENTION

This invention relates to films useful for activating anaerobic adhesives and coatings, and more particularly to labels containing an anaerobic activator on a label surface.

### BACKGROUND OF THE INVENTION

Anaerobic adhesive systems are those that are stable in the presence of oxygen, but will polymerize in the absence of oxygen. Polymerization is generally initiated by the presence of a peroxy compound. Typical anaerobic compositions include (meth)acrylic functional monomers, or prepolymers with acrylate or methacrylate ester groups, especially poly(meth)acrylic functional monomers, organic hydroperoxy or perester initiators, accelerators and stabilizers. Anaerobic adhesives may also include one or more tackifiers.

Cure of the anaerobic composition can be accelerated by the presence of a suitable metal, such as a transition metal, or its ions. Metal accelerators have been sprayed or brushed onto at least one the surfaces to be joined. It is well known in the art to employ primers to supply the transition metal to the curable composition. Typical primers are solutions in a volatile or organic solvent of a copper(II) carboxylate salt or copper(II) complex such as copper(II) 2-ethylhexanoate or copper(II) acetylacetonate. In normal use, the primer is applied to one or both surfaces of a substrate to be bonded and the solvent allowed to evaporate, after which, the adhesive is applied and the substrate joined until bonded. U.S. Pat. No. 4,990,281 describes a primer that is a solution in a volatile organic solvent of a salt of a metal ion selected from Cu(II), Co(II), Mn(II), Mn(III), and Cr(III) and a counter ion derived from a (meth)acrylic functional acid phosphate monomer.

Other methods of employing accelerators for the free radical polymerization of anaerobic compositions is to use a two-part adhesive system in order to avoid stability problems during storage. For example, the two parts of the adhesive each contain reactive monomers. The initiators for the free radical reaction are kept in one part of the adhesive and the transition metal accelerators and an aerobically cured monomer(s), oligomer(s) and/or prepolymer(s) in the other part. Each part remains stable until it is mixed with the other, which initiates curing of the adhesive composition.

It would be desirable to supply the accelerator in film form. This would provide a more convenient method of anaerobic adhesive use and eliminate the need to spray or brush the accelerator onto the surface or to supply the accelerator in a two part liquid system.

### SUMMARY OF THE INVENTION

In one embodiment, this invention relates to a label that comprises;

(a) a polymer facestock having an upper surface and a lower surface, and

(b) an activating layer having an upper surface and a lower surface wherein the upper surface of the activating layer underlies the facestock, and the activating layer contains at least one activating agent for anaerobic curing.

In yet another embodiment, this invention relates to a label that comprises;

(a) a polymer facestock having an upper surface and a lower surface,

(b) an anaerobic adhesive having an upper surface and a lower surface wherein the upper surface of the adhesive is in contact with the lower surface of the facestock,

(c) a release liner having an upper release surface and a lower release surface wherein the upper release surface of the release liner is in contact with the lower surface of the anaerobic adhesive, and

(d) an activating layer having an upper surface and a lower surface wherein the upper surface of the activating layer is in contact with the lower release surface of the release liner.

In addition, the present invention relates to a method of labeling substrates utilizing the above described labels and anaerobic adhesives.

### BRIEF DESCRIPTION OF THE DRAWINGS

FIG. 1 is a cross section of a first embodiment of a label construction of the present invention.

FIGS. 2 and 3 are cross sections of multilayer label constructions of the present invention.

FIG. 4 is a cross section of a label of the invention wherein anaerobic adhesive has been applied to the activator layer.

FIGS. 5a and 5b are cross sections of another embodiment of a label construction of the present invention prior to and post activation, respectfully.

### DESCRIPTION OF THE INVENTION

The term “overlies” and cognate terms such as overlying and the like, when referring to the relationship of one or a first layer relative to another or a second layer, refers to the fact that the first layer partially or completely overlies the second layer. The first layer overlying the second layer may or may not be in contact with the second layer. For example, one or more additional layers may be positioned between the first and the second layer. The term “underlies” and cognate terms such as “underlying” and the like have similar meanings except that the first layer partially or completely lies under, rather than over the second layer.

A label of a first embodiment (hereinafter sometimes referred to as the “first embodiment” or the “label of the first embodiment”) comprises:

(a) a polymer facestock having an upper and a lower surface, and

(b) an activating layer having an upper surface and a lower surface wherein the upper surface of the activating layer underlies the facestock, and the activating layer contains at least one activating agent for anaerobic curing.

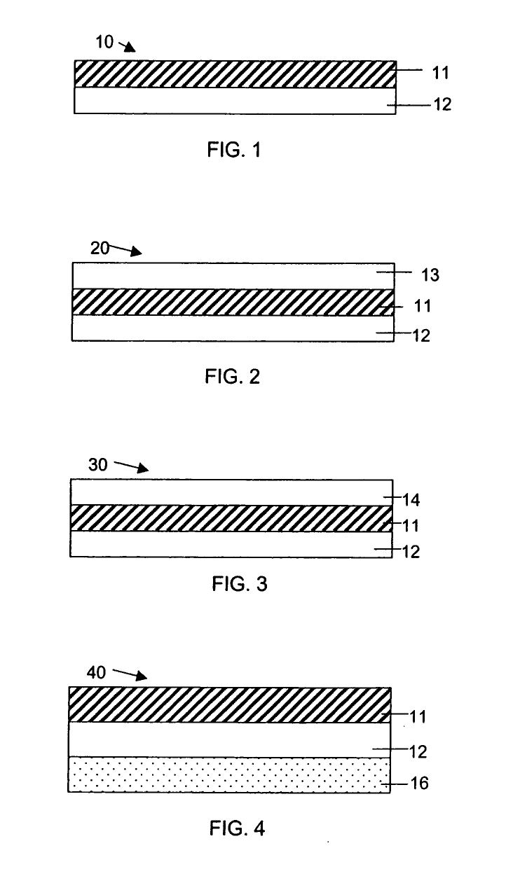

The anaerobic activator label of the first embodiment is illustrated in FIG. 1. Label 10 comprises a polymer facestock 11 having an upper surface and a lower surface, an activating layer 12 having an upper surface and a lower surface wherein the upper surface of the activating layer 12 underlies the lower surface of the facestock 11.

The labels of the first embodiment of this invention may, and generally do contain other layers. For example, as shown in FIG. 2, the label 20 may contain a metal layer 13 that overlies and is in contact with the facestock layer 11. Alternatively, a print layer 14 can be on the upper surface of the facestock 11 as illustrated in FIG. 3. The label 30 illustrated in FIG. 3 comprises facestock 11 having an upper surface and a lower surface, an activating layer 12 having an upper surface and a lower surface wherein the upper surface of layer 12 is in contact with the lower surface of the facestock 11, and a print layer 14 that overlies and is in contact with the upper surface of the facestock 11.

The labels of FIGS. 1-3 may also contain adhesion promoting layers (APLs) between one or more of the layers shown. For example, an APL can be inserted between facestock 11 and the activating layer 12; between the facestock and the metal layer or print layer; etc.

When the labels of FIGS. 1-3 are to be applied to a substrate, an anaerobic adhesive, described in detail below, is applied to the lower surface of the activating layer 12, generally just prior to application of the label to the substrate. Alternatively, the anaerobic adhesive is applied to at least a portion of the substrate to which the label is to be applied. The label is then applied so that the activating layer is in contact with the anaerobic adhesive on the substrate. As illustrated in FIG. 4, label 40 comprises a facestock 11, having an upper surface and a lower surface, and an activating layer 12 having an upper surface and a lower surface, wherein the upper surface of the activating layer 12 underlies the lower surface of the facestock 11, and an adhesive layer 16 having an upper surface and a lower surface wherein the upper surface of adhesive layer 16 is in contact with the lower surface of the activating layer 12. Although not shown in FIG. 4, the label illustrated therein may contain additional layers such as a print layer or metal layer overlying facestock 11, and/or one or more adhesion promoting layers (APLs).

In second embodiment (hereinafter referred to as “the second embodiment”) the present invention relates to a label comprising;

(a) a polymer facestock having an upper surface and a lower surface,

(b) an anaerobic adhesive layer having an upper surface and a lower surface wherein the upper surface of the adhesive layer is in contact with the lower surface of the facestock,

(c) a release liner having an upper release surface and a lower release surface wherein the upper release surface of the release liner is in contact with the lower surface of the anaerobic adhesive layer, and

(d) an activating layer having an upper surface and a lower surface wherein the upper surface of the activating layer is in contact with the lower release surface of the release liner.

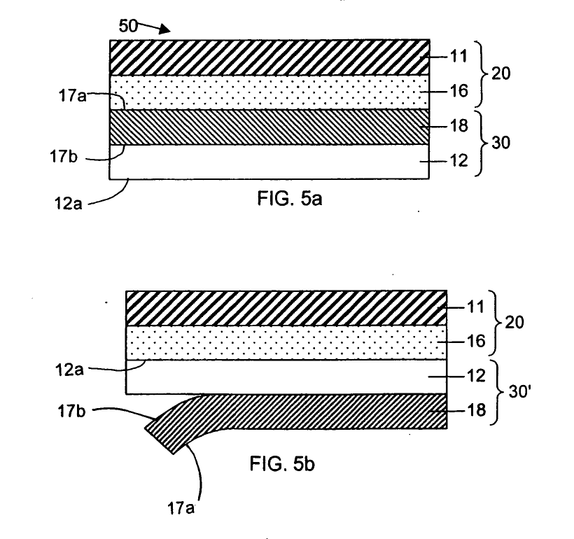

The label of the second embodiment is illustrated in FIG. 5a wherein label 50 comprises facestock 11, having an upper surface and a lower surface, an anaerobic adhesive layer 16 having an upper surface and a lower surface, wherein the upper surface of the adhesive layer is in contact with the lower surface of facestock 11, a release liner 18 having an upper release surface 17a and a lower release surface 17b wherein the upper release surface 17a is in contact with the lower surface of the anaerobic adhesive layer, and an activating layer 12 having an upper surface and a lower surface 12a wherein the upper surface of the activating layer is in contact with the lower release surface 17b of release liner 18. The laminate of layers 11 and 16 is indicated as 20 and the laminate of layers 18 and 12 is indicated as 30.

In order to activate the anaerobic adhesive layer 16 of the second embodiment, laminate 30, comprising the activating layer 12 and release liner 18 is separated from laminate 20 comprising the facestock 11 and anaerobic adhesive layer 16 at the interface between laminates 20 and 30. Laminate 30 is then inverted and reapplied to the lower surface of anaerobic adhesive layer 16 as laminate 30′, so that the previously exposed surface 12a of activating layer 12 is now in contact with the lower surface of the anaerobic adhesive layer 16. This construction is illustrated in FIG. 5b. Release liner 18 can be subsequently removed from the activating layer 12 as illustrated in FIG. 5b.

Anaerobic Adhesives

By the term “anaerobic adhesive,” there is meant a mixture of an anaerobic resin system and a catalyst system, and if desired, a tackifier, which in a solvent-free state is permanently tacky at room temperature, and which firmly adheres to a variety of ordinary surfaces upon contact without the need of more than finger pressure. Further, it must conform to the surface irregularities of normal surfaces and have a sufficient shear modulus to resist removal subsequent to application to a surface.

By a catalyst system there is meant an acid or base catalyzed system typically containing at least one peroxy initiator. Typical of the peroxy compounds that may be employed as initiators are the hydroperoxides, including organic hydroperoxides of the formula R′OOH, wherein R′ is generally a hydrocarbon radical containing up to 18 carbon atoms, such as alkyl, aryl or aralkyl radical containing from 1 to about 12 carbon atoms.

The anaerobic resin systems are well known to those skilled in the art. Anaerobic curing compositions are formulated such that they are air stabilized but readily polymerize in the absence of oxygen. U.S. Pat. Nos. 3,970,505; 3,993,815; 3,996,308; 4,039,705; 4,092,374; 4,118,442; 4,990,281; 6,013,750; 6,096,842 and 6,583,289 describe anaerobis resins and are hereby incorporated herein by reference.

In one embodiment, the anaerobic resin system is based on acrylates and/or methacrylates, i.e., the reactive component consists predominantly of an ester of acrylic acid and/or methacrylic acid. Other reactive components, for example, copolymerizable allyl or vinyl compounds may also be present. The acrylates or methacrylates may contain one or more reactive double bonds. The alcohol radical may contain hetero atoms, for example in the form of ether, alcohol, carboxylic acid, ester and urethane groups.

Suitable epoxy-acrylate resins useful in the present invention include those having one or more functional oxiranyl (oxirane) groups and an acrylic-based resin formed from alkylene glycol diacrylate monomers. Such alkylene glycol diacrylate monomers can be selected from mono-, di-, tri-, tetra- and polyethylene glycol dimethacrylate and corresponding diacrylates; dipentamethylene glycol dimethacrylate; tetraethylene glycol dichloroacrylate; diglycerol diacrylate; diglycerol tetramethacrylate; butylene glycol dimethacrylate; neopentyl glycol diacrylate; and trimethylopropane triacrylate. Additional suitable acrylic-based resin systems include ethoxylated trimethylol propane triacrylate, trimethylol propane trimethacrylate, dipentaerythritol monohydroxy pentacrylate, pentaerythritol triacrylate, ethoxylated trimethylol propane triacrylate, 1,6-hexanedioldiacrylate, neopentyl glycol diacrylate, pentaerythritol tetraacrylate, 1,2-butylene glycoldiacrylate, trimethylopropane ethoxylate trimethacrylate, glyceryl propoxylate trimethacrylate, trimethylolpropane trimethacrylate, dipentaerythritol monohydroxy pentamethacrylate, tripropylene glycol dimethacrylate, neopentyl glycol propoxylate dimethacrylate, 1,4-butanediol dimethacrylate, polyethylene glycol dimethacrylate, triethyleneglycol dimethacrylate, butylene glycol dimethacrylate, ethoxylated bisphenol A dimethacrylate, combinations thereof, and the like.

Yet other suitable resins include urethane-acrylate type monomers, such as urethane-acrylate-capped prepolymers based on polybutadiene polyols or polyamines and acrylates such as those disclosed hereinabove. Monofunctional acrylate esters (esters containing one acrylate group) also may be used. Particularly useful are the acrylate esters having a relatively polar moiety. Polar groups may be selected from labile hydrogen, heterocyclic ring, hydroxy, amino, cyano, and halogen polar groups; examples include, cyclohexyl methacrylate, tetrahydrofurfuryl methacrylate, hydroxyethyl acrylate, hydroxypropyl methacrylate, t-butylaminoethyl methacrylate, cyanoethylacrylate, and chloroethyl methacrylate. The acrylate esters can be incorporated as reactive diluents capable of copolymerizing with various other polymerizable materials.

The anaerobic adhesive system of the present invention can contain one or more additives including a flexibilizer, a plasticizer, a stabilizer and/or a tackifier. In one embodiment, the flexibilizer is a thermoplastic polymer, for example, polyvinyl chloride, polyvinyl ethers, polyvinyl acetates, acrylic based polymers, polyurethanes, polyesters, polyamides, natural and synthetic elastomers and the like, as well as mixtures thereof.

A suitable plasticizer can be a high-boiling temperature solvent or a softening agent. An example of a suitable plasticizer is an ester made from an anhydride or acid and a suitable alcohol having from about 6 carbon atoms to about 13 carbon atoms. Other suitable plasticizers include adipate, phosphate, benzoate or phthalate esters, polyalkylene oxides, sulfonamides, and the like. The plasticizers include dioctyl adipate plasticizer (DOA), triethylene glycol di-2-ethylhexanoate plasticizer (TEG-EH), trioctyl trimellitate plasticizer (TOTM), glyceryl triacetate (triacetin plasticizer), 2,2,4-trimethyl-1,3-pentanediol diisobutyrate plasticizer (TXIB), diethyl phthalate plasticizer (DEP), dioctyl terephthalate plasticizer (DOTP), dimethyl phthalate plasticizer (DMP), dioctyl phthalate plasticizer (DOP), dibutyl phthalate plasticizer (DBP), ethylene oxide, toluene sulfonamide, and dipropylene glycol benzoate. Other commercially available plasticizers may also be useful.

Useful stabilizers provide radical trapping activity and are generally selected with reference to at least some of the following considerations: the compatibility with the resin system, the temperature stability of the stabilizer at processing temperatures, whether the stabilizer will. cause undesirable coloring, and that the stabilizer will not interact with other additives. Further, the stabilizer should inhibit ageing during processing, during storage and during the end use. Useful stabilizers include tert-butylhydroquinone, propyl gallate, sodium nitrate, sodium nitrite, butylated hydroxytoluene (BHT), and butylated hydroxyanisole (BHA) and analogs and derivatives. Suitable additives are commercially available from such suppliers as Ciba Specialty Chemicals, Inc. (Tarrytown, N.Y.) and Ferro Corp. (Independence, Ohio).

A tackifier may be used to induce or enhance pressure sensitive properties of the adhesive. Typical tackifiers include rosins, rosin derivatives, terpenes, synthetic tacky resins, low molecular weight polyacrylates and the like as well as mixtures thereof.

It is desirable to avoid the potential problem of incomplete cure of the anaerobic adhesive at the edges or periphery of the labels of the present invention because of the relatively greater exposure to air (oxygen) at the edges. In one embodiment of the present invention, trimethylolpropane triacrylate (TMPTA) is added to the anaerobic adhesive composition in order to achieve a more aggressive cure of the adhesive. In another embodiment, a photoinitiator is added to the anaerobic adhesive composition. With the photoinitiator present, there are two curing mechanisms present, i.e., the peroxy initiated cure and the photoinitiated cure, resulting in a more complete cure of the adhesive composition.

Facestocks

The polymer facestock layer 11 may be a mnonolayer film or a multilayer film. The multilayer film may comprise from two to ten or more layers. The polymer facestock may be oriented or not oriented. Depending on the end use of the label, the polymer facestock may be transparent or opaque. Opaque facestocks generally comprise a polymer as described below and one or more pigments to provide the facestock, or one layer of a multilayer facestock with the desired color. Pigments useful for this purpose are well known in the art. For example, white films can be prepared by introducing titanium dioxide and other white pigments into the polymer. Carbon black may be introduced to provide a black or grey facestock or film.

A wide variety of polymer film materials are useful in preparing the facestocks. For example, the polymer film material may include polymers and copolymers such as at least one polyolefin, polyacrylate, polystyrene, polyamide, polyvinyl alcohol, poly(alkylene acrylate), poly(ethylene vinyl alcohol), poly(alkylene vinyl acetate), polyurethane, polyacrylonitrile, polyester, polyester copolymer, fluoropolymer, polysulfone, polycarbonate, styrene-maleic anhydride copolymer, styrene-acrylonitrile copolymer, ionomers based on sodium or zinc salts of ethylene methacrylic acid, cellulosics, polyacrylonitrile, alkylene-vinyl acetate copolymer, or mixtures of two or more thereof.

The polyolefins that can be utilized as the polymer film material include polymers and copolymers of olefin monomers containing 2 to about 12 carbon atoms such as ethylene, propylene, 1-butene, etc., or blends of mixtures of such polymers and copolymers. In one embodiment the polyolefins comprise polymers and copolymers of ethylene and propylene. In another embodiment, the polyolefins comprise propylene homopolymers, and copolymers such as propylene-ethylene and propylene-1-butene copolymers. Blends of polypropylene and polyethylene with each other, or blends of either or both of them with polypropylene-polyethylene copolymer also are useful. In another embodiment, the polyolefin film materials are those with a very high propylenic content, either polypropylene homopolymer or propylene-ethylene copolymers or blends of polypropylene and polyethylene with low ethylene content, or propylene-1-butene copolymers or blend of polypropylene and poly-1-butene with low butene content. Useful propylene homopolymers and copolymers are described in U.S. Pat. No. 5,709,937 (Adams et al). The copolymers include propylene-ethylene copolymers containing up to about 10% by weight of ethylene, and propylene-1-butene copolymers containing up to about 15% by weight of 1-butene. Oriented films described in the '937 patent are clear films useful as the facestock in the labels of the present invention. The disclosure of U.S. Pat. No. 5,709,937 is hereby incorporated by reference.

Various polyethylenes can be utilized as the polymer film material including low, medium, and high density polyethylenes, and mixtures thereof. An example of a useful low density polyethylene (LDPE) is Rexene 1017 available from Huntsman. An example of a useful high density polyethylene (HDPE) is Formoline LH5206 available from Formosa Plastics. In one embodiment the polymer film material comprises a blend of 80 to 90% HDPE and 10-20% of LDPE.

The propylene homopolymers that can be utilized as the polymer film material in the invention, either alone, or in combination with a propylene copolymer as described herein, include a variety of propylene homopolymers such as those having melt flow rates (MFR) from about 0.5 to about 20 as determined by ASTM Test D 1238. In one embodiment, propylene homopolymers having MFRs of less than 10, and more often from about 4 to about 10 are particularly useful. Useful propylene homopolymers also may be characterized as having densities in the range of from about 0.88 to about 0.92 g/cm³. A number of useful propylene homopolymers are available commercially from a variety of sources, and some useful polymers include: 5A97, available from Dow Chemical and having a melt flow of 12.0 g/10 min and a density of 0.90 g/cm³; DX5E66, also available from Dow Chemical and having an MFI of 8.8 g/10 min and a density of 0.90 g/cm³; and WRD5-1057 from Dow Chemical having an MFI of 3.9 g/10 min and a density of 0.90 g/cm³. Useful commercial propylene homopolymers are also available from Fina and Montel.

Examples of useful polyamide resins include resins available from EMS American Grilon Inc., Sumter, S.C. under the general tradename Grivory such as CF6S, CR-9, XE3303 and G-21. Grivory G-21 is an amorphous nylon copolymer having a glass transition temperature of 125° C., a melt flow index (DIN 53735) of 90 mI/l0 min and an elongation at break (ASTM D638) of 15. Grivory CF65 is a nylon 6/12 film grade resin having a melting point of 135° C., a melt flow index of 50 ml/10 min, and an elongation at break in excess of 350%. Grilon CR9 is another nylon 6/12 film grade resin having a melting point of 200° C., a melt flow index of 200 ml/10 min, and an elongation at break at 250%. Grilon XE 3303 is a nylon 6.6/6.10 film grade resin having a melting point of 200° C., a melt flow index of 60 ml/10 min, and an elongation at break of 100%. Other useful polyamide resins include those commercially available from, for example, International Paper of Wayne, N.J. under the Uni-Rez product line, and dimer-based polyamide resins available from Bostik, International Paper, Fuller, Henkel (under the Versamid product line). Other suitable polyamides include those produced by condensing dimerized vegetable acids with hexamethylene diamine. Examples of polyamides available from International Paper include Uni-Rez 2665; Uni-Rez 2620; Uni-Rez 2623; and Uni-Rez 2695.

Polystyrenes can also be utilized as the polymer facestock material and these include homopolymers as well as copolymers of styrene and substituted styrene such as alpha-methyl styrene. Examples of styrene copolymers and terpolymers include: acrylonitrile-butene-styrene (ABS); styrene-acrylonitrile copolymers (SAN); styrene butadiene (SB); styrene-maleic anhydride (SMA); and styrene-methyl methacrylate (SMMA); etc. An example of a useful styrene copolymer is KR-10 from Phillips Petroleum Co. KR-10 is believed to be a copolymer of styrene with 1,3-butadiene.

Polyurethanes also can be utilized as the polymer film material, and the polyurethanes may include aliphatic as well as aromatic polyurethanes.

The polyurethanes are typically the reaction products of (A) a polyisocyanate having at least two isocyanate (—NCO) functionalities per molecule with (B) at least one isocyanate reactive group such as a polyol having at least two hydroxy groups or an amine. Suitable polyisocyanates include diisocyanate monomers, and oligomers.

Useful polyurethanes include aromatic polyether polyurethanes, aliphatic polyether polyurethanes, aromatic polyester polyurethanes, aliphatic polyester polyurethanes, aromatic polycaprolactam polyurethanes, and aliphatic polycaprolactam polyurethanes. Particularly useful polyurethanes include aromatic polyether polyurethanes, aliphatic polyether polyurethanes, aromatic polyester polyurethanes, and aliphatic polyester polyurethanes.

Examples of commercial polyurethanes include Sancure 27107 and/or Avalure UR 4457 (which are equivalent copolymers of polypropylene glycol, isophorone diisocyanate, and 2,2-dimethylolpropionic acid, having the International Nomenclature Cosmetic Ingredient name “PPG-17/PPG-34/IPDI/DMPA Copolymer”), Sancure 8787, Sancure 8157, Sancure 13017, Sancure 27157, Sancure 18287, Sancure 20267, and Sancure 124717 (all of which are commercially available from Noveon, Cleveland, Ohio), Bayhydrol DLN (commercially available from Bayer Corp., McMurray, Pa.), Bayhydrol LS-2033 (Bayer Corp.), Bayhydrol 123 (Bayer Corp.), Bayhydrol PU402A (Bayer Corp.), Bayhydrol 110 (Bayer Corp.), Witcobond W-320 (commercially available from Witco Performance Chemicals), Witcobond W-242 (Witco Performance Chemicals), Witcobond W-160 (Witco Performance Chemicals), Witcobond W-612 (Witco Performance Chemicals), Witcobond W-506 (Witco Performance Chemicals), NeoRez R-600 (a polytetramethylene ether urethane extended with isophorone diamine commercially available from Avecia, formerly Avecia Resins), NeoRez R-940 (Avecia), and NeoRez R-960 (Avecia).

Examples of such aliphatic polyether polyurethanes include Sancure 27107 and/or Avalure UR 4457, Sancure 8787, NeoRez R-600, NeoRez R-966, NeoRez R-967, and Witcobond W-320.

In one embodiment, the facestock comprises at least one polyester polyurethane. Examples of these urethanes include those sold under the names “Sancure 2060” (polyester-polyurethane), “Sancure 2255” (polyester-polyurethane), “Sancure 815” (polyester-polyurethane), “Sancure 878” (polyether-polyurethane) and “Sancure 861” (polyether-polyurethane) by the company Sanncor, under the names “Neorez R-974” (polyester-polyurethane), “Neorez R-981” (polyester-polyurethane) and “Neorez R-970” (polyether-polyurethane) by the company Avecia, and the acrylic copolymer dispersion sold under the name “Neocryl XK-90” by the company Avecia.

Polyesters prepared from various glycols or polyols and one or more aliphatic or aromatic carboxylic acids also are useful film materials. Polyethylene terephthalate (PET) and PETG (PET modified with cyclohexanedimethanol) are useful film forming materials which are available from a variety of commercial sources including Eastman. For example, Kodar 6763 is a PETG available from Eastman Chemical. Another useful polyester from duPont is Selar PT-8307, which is polyethylene terephthalate.

Acrylate polymers and copolymers and alkylene vinyl acetate resins (e.g., EVA polymers) also are useful as the film forming materials in the preparation of the constructions of the invention. Commercial examples of available polymers include Escorene UL-7520 (Exxon), a copolymer of ethylene with 19.3% vinyl acetate; Nucrell 699 (duPont), an ethylene copolymer containing 11% of methacrylic acid, etc. lonomers (polyolefins containing ionic bonding of molecular chains) also are useful. Examples of ionomers include ionomeric ethylene copolymers such as Surlyn 1706 (duPont) which is believed to contain interchain ionic bonds based on a zinc salt of ethylene methacrylic acid copolymer. Surlyn 1702 from duPont also is a useful ionomer.

Polycarbonates also are useful, and these are available from the Dow Chemical Co. (Calibre) G.E. Plastics (Lexan) and Bayer (Makrolon). Most commercial polycarbonates are obtained by the reaction of bisphenol A and carbonyl chloride in an interfacial process. Molecular weights of the typical commercial polycarbonates vary from about 22,000 to about 35,000, and the melt flow rates generally are in the range of from 4 to 22 g/10 min.

In one embodiment, the facestock polymer material may comprise fluorinated polymer. The fluorinated polymer includes a thermoplastic fluorocarbon such as polyvinylidene fluoride (PVDF). The fluorinated polymer also can include copolymers and terpolymers of vinylidene fluoride. A useful thermoplastic fluorocarbon is the polyvinylidene fluoride known as Kynar, a trademark of Pennwalt Corp. This polymer is a high molecular weight (400,000) polymer that provides a useful blend of durability and chemical resistance properties. Generally, a high molecular weight PVDF resin, with a weight average molecular weight of about 200,000 to about 600,000 is used.

The polymer facestock material may be free of inorganic fillers and/or pigments for clear facestocks and clear labels, or the polymer facestock material may be cavitated and/or contain inorganic fillers and other organic or inorganic additives to provide desired properties such as appearance properties (opaque or colored films), durability and processing characteristics. Nucleating agents can be added to increase crystallinity and thereby increase stiffness. Examples of useful materials include calcium carbonate, titanium dioxide, metal particles, fibers, flame retardants, antioxidant compounds, heat stabilizers, light stabilizers, ultraviolet light stabilizers, antiblocking agents, processing aids, acid acceptors, etc. Opaque and/or white facestocks are often utilized when the labels described herein do not contain a metal layer overlying the facestock layer.

The polymer facestock material is chosen to provide a continuous polymer film in the film structures of this invention with the desired properties such as improved tensile strength, elongation, impact strength, tear resistance, and optics (haze and gloss). The choice of polymeric facestock forming material also is determined by its physical properties such as melt viscosity, high speed tensile strength, percent elongation etc. In one embodiment, clear or transparent facestocks are used in the label construction when clear or transparent labels are desired.

The thickness of the polymer facestock may be from about 0.1 to about 10 mils, or from about 1 to about 5 mils. In one embodiment the thickness of the facestock is from about 1 to about 3 mils. The facestock may comprise a single layer, or the film can be a multilayer film of two or more adjacent layers. For example the film can comprise one layer of a polyolefin and one layer of a blend of a polyolefin and a copolymer of ethylene and vinyl acetate (EVA). In another embodiment the film comprises three layers, a base or core layer of, for example, a polyolefin, and skin layers in both sides-of the base or core layer which may be comprised of the same or different polymer blends. The individual layers of a multilayer facestock may be selected to provide desirable properties.

The monolayer and multilayer film facestocks useful in the labels useful herein can be manufactured by those processes known to those skilled in the art such as by casting or extrusion. In one embodiment, the films are manufactured by polymer extrusion or coextrusion processes. The extrudate or coextrudate of polymeric film materials is formed by simultaneous extrusion from a suitable known type of extrusion or co-extrusion die, and in the case of a coextrudate, the layers are adhered to each other in a permanently combined state to provide a unitary coextrudate.

In addition to coextrusion, the multilayer film facestocks useful in the present invention may be prepared by extrusion of a continuous film to form one layer followed by the application of one or more additional layers on the extruded layer by extrusion of one or more additional layers; by lamination of a preformed polymer film to a preformed functional film; or by deposition of additional layers on the preformed film from an emulsion or solution of a polymeric film forming material.

In one embodiment, the facestocks used in the present invention are not oriented. That is, the facestock and films are not subjected to a hot-stretching and annealing step. In other embodiments, the facestock contained in the labels used in the present invention may be oriented in the machine direction (uniaxially) or in both the machine and cross directions (biaxially) by hot-stretching and annealing by techniques well known to those skilled in the art. For example, the films may be hot-stretched in the machine direction only at a ratio of at least 2:1 and more often, at a ratio of between about 2:1 to about 9:1. After the film has been hot stretched, it is generally passed over annealing rolls where the film is annealed or heat-set at temperatures in the range of from about 50° C., more often 100° C. to about 150° C., followed by cooling. In another embodiment, the facestock is a biaxially oriented.

It is desirable that the films exhibit a degree of stiffness in the machine direction and the cross direction to facilitate handling, printing and dispensing. Thus, in one embodiment, the stiffness in the machine direction, and the cross direction should be at least about 14 Gurley (mg), as determined using TAPPI Test T543 pm and in a further embodiment the Gurley stiffnesses in both directions are within about 5 Gurley units (sometimes referred to as a balanced stiffness).

Polymer facestocks useful in the labels of the present invention are available commercially from a variety of sources such as Avery Dennison Corp., Painesville, Ohio; AMTOPP, a division of Interplast Group LTD, Livingston, N.J. 07039; Exxon Mobil Chemical Co., Macdon, N.Y. 14502; AET Films, New Castle, Del. 19720; and UCB Films Inc., Smyrna, Ga. 30080. Clear films and white films are available.

Specific examples of useful polypropylene facestock films that are commercially available include the following:

| | | | Gurley Stiffness | |
|---|---|---|---|---|
| | | | (mg) | |
| Film Name | Thickness | Type | MD | CD |
| Mobil BOPP W/434TC | 2 | Clear | 15 | 18 |
| AMTOPP BOPP | 2 | Clear | 16 | 17 |
| UCB CA-200 BOPP | 2 | Clear | 25 | 28 |
| AET CSL 111-125 C/S | 3.2 | White | 48 | 71 |

The surface energy of both surfaces of the facestock can be enhanced by treatments such as corona discharge, flame, plasma, etc. to provide the surfaces with desirable properties such as improved adhesion to subsequently applied layers. Procedures for corona treating and flame treating of polymer films are well known to those skilled in the art. In one embodiment, a facestock is corona discharge treated on the upper surface and flame treated on the lower surface.

Activating Layer

The labels of the present invention also comprise an activating layer 12 having an upper surface and a lower surface wherein the upper surface of the activating layer 12 underlies the facestock. In one embodiment, the activating layer is in contact with and adhered to the lower surface of the facestock 11. In other embodiments, adhesion promoting layers may be inserted between the facestock and the activating layer, with the upper surface of the activating layer underlying the lower surface of the adhesion promoting layer.

The activating layer comprises at least one activating agent for anaerobic curing. Activating agents typically comprise at least one transition metal. Transition metals are useful in accelerating the cure mechanism of peroxide initiated acrylic anaerobic compositions. Any transition metal compound can be used provided that the compound exhibits reactivity as an activator. Reactivity is measured by the speed of cure of the anaerobic adhesive. The transition metals are those metals that have their valence electrons in a “d” subshell. Included in this group are the metals of Groups 3, 4, 5, 6, 7, 8, 9, 10 and 11 of the Periodic Table of Elements. Particularly useful transition metals include copper, chromium, manganese, iron, cobalt, nickel, and molybdenum. Alloys of these transition metals with minor amounts of other metals also can be utilized. For example, RotoStar 801-103 pigment, a bronze pigment based on 90% copper and 10% zinc is useful as an activating agent. RotoStar 801-103 pigment is available from Eckart America and contains a UV curable monomer.

The transition metal compound may be in the form of an inorganic or organometallic compound, including oxides, salts, and organometallic chelates and complexes. Suitable organic salts include the sulfates, nitrates, chlorides, bromides, phosphates and sulfides. Suitable organic salts include the alkoxides, for example, the methoxides and ethoxides, as well as the carboxylates, including the acetates, hexoates, octoates, ethylhexanoates, and naphthenlates. Other suitable transition metal complexes include the acetylacetonates and the hexafluoroacetylacetonates. Particularly useful transition metal compounds include copper 2-ethylhexanoate, copper acetate, copper naphthenate, copper octoate, copper hexoate, and copper hexafluoroacetylacetonate. The concentration of activating agent in the activating layer depends on the composition and thickness of the anaerobic adhesive layer used and should be sufficient to result in curing of the anaerobic adhesive at the edges or periphery of the label construction, where exposure to air (oxygen) is relatively greater.

The activator can be an organocopper catalyst, such as LOCTITE 7469 PRIMER, which is commercially available from Henkel Loctite Corp. In other embodiments, suitable alternative activators include organo-iron compounds, zirconium complexes (such as K-KAT XC-923), metal chelates (such as NACURE XC-9206), and antimony-based catalysts (such as NACURE XC-7231), all of which are commercially available from King Industries, Inc. Yet other suitable activators in alternative embodiments include nitrogen and sulfur based activators.

In one embodiment, the activator is provided in the form of a salt of an acid phosphate monomer. The acid phosphate monomers have the formula 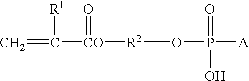
where R′ is H or methyl, R² is a divalent organic residue having from 2-40 carbon atoms and A is OH or H₂C═C(R¹)—COOR²O—. Suitably, R² is C₂-C₁₀ alkylene. Examples of commercially available materials include mono(methacryloxyethyl) phosphate; bis(methacryloxyethyl) phosphate; mono(acryloxyethyl) phosphate; bis(acryloxyethyl) phosphate; mixed mono and bis(acryloxyhexyl) phosphate and mixed mono and bis(methacryloxyhexyl) phosphate. Such acid phosphate monomer salts are described in U.S. Pat. No. 4,731,146, the disclosure of which is hereby incorporated by reference.

In one embodiment, the transition metal activator is incorporated into a coating composition that is coated onto the lower surface of the facestock to form an activating layer. The activating layer can comprise a binder and an activating agent. The activating layer can be prepared from a mixture of a binder and the activating agent, generally in a diluent or solvent for the binder. The amount of activating agent mixed with and incorporated into the binder may vary over a wide range.

The binder that may be utilized in the activating layer may be any film forming monomer, oligomer or polymer or combinations thereof. The binders may be water soluble, organic solvent soluble, or insoluble in water and organic solvents since the coating compositions may be applied as solutions, dispersions or emulsions. Non-limiting examples of useful binders include polyurethanes, polyolefins, polyacryls, polymethacryls, polyamides, polyvinyl acetates, polyvinyl alcohols, polyvinyl ethers, polyacrylonitriles, polystyrenes, polyvinyl pyrrolidones, polyvinyl chlorides, poly(alkylene oxides), proteins, cellulosic polymers, gelatine, and copolymers of one or more monomers including olefins, (meth)acrylates, vinyl acetates, allyl acetates, vinyl chlorides, acrylonitriles, N-vinyl pyrrolidones, N-vinyl oxazolidones, vinyl ethers and other allylic and vinylic monomers.

The binder may also include an ethylenically unsaturated oligomer. Suitable ethylenically unsaturated oligomers include polyether urethane acrylate oligomers (e.g., CN986 available from Sartomer Company, Inc., (West Chester, Pa.)) and BR344, BR3731 and STC3-149 available from Bomar Specialties Co. (Winsted, Conn.)), acrylate oligomers based on tris(hydroxyethyl)isocyanurate, (available from Sartomer Company, Inc.), (meth)acrylated acrylic oligomers, (available from Cognis (Ambler, Pa.), polyester urethane acrylate oligomers (e.g., CN966 and CN973 available from Sartomer Company, Inc. and BR7432 available from Bomar Specialty Co.), polyurea urethane acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,629,287 to Bishop et al., all of which are hereby incorporated by reference), polyether acrylate oligomers (e.g., Genomer 3456 available from Rahn A G (Zurich, Switzerland), polyester acrylate oligomers (e.g., Ebecryl 80, 584, and 657 available from UCB Radcure (Atlanta, Ga.)), polyurea acrylate oligomers (e.g., oligomers disclosed in U.S. Pat. Nos. 4,690,502 and 4,798,852 to Zimmerman et al., U.S. Pat. No. 4,609,718 to Bishop, and U.S. Pat. No. 4,1529,287 to Bishop et al., the specifications of which are hereby incorporated by reference), epoxy acrylate oligomers (e.g., CN120 available from Sartomer Company, Inc., and Ebecryl 3201 and 3604 available from UCB Radcure), hydrogenated polybutadiene oligomers (e.g., Echo Resin MBNX available from Echo Resins and Laboratory (Versailles, Mo.)), and combinations thereof.

In one embodiment, the binder includes at least one polyfunctional ethylenically unsaturated monomer. Suitable polyfunctional ethylenically unsaturated monomers include, without limitation, alkoxylated bisphenol A diacrylates such as ethoxylated bisphenol A diacrylate with ethoxylation being 2 or greater, preferably ranging from 2 to about 30 (e.g. SR349 and SR601 available from Sartomer Company, Inc. West Chester,. Pa. and Photomer 4025 and Photomer 4028, available from Cognis Corp. (Ambler, Pa.)), and propoxylated bisphenol A diacrylate with propoxylation being 2 or greater, preferably ranging from 2 to about 30; propoxylated neopentyl glycol diacrylate (e.g., SR9003, Sartomer Company, Inc.); methylolpropane polyacrylates with and without alkoxylation such as ethoxylated trimethylolpropane triacrylate with ethoxylation being 3 or greater, preferably ranging from 3 to about 30 (e.g., Photomer 4149, Cognis Corp., and SR499, Sartomer Company, Inc.), propoxylated trimethylolpropane triacrylate with propoxylation being 3 or greater, preferably ranging from 3 to 30 (e.g., Photomer 4072, Cognis Corp. and SR492, Sartomer), and ditrimethylolpropane tetraacrylate (e.g., Photomer 4355, Cognis Corp.); alkoxylated glyceryl triacrylates such as propoxylated glyceryl triacrylate with propoxylation being 3 or greater (e.g., Photomer 4096, Cognis Corp. and SR9020, Sartomer); erythritol polyacrylates with and without alkoxylation, such as pentaerythritol tetraacrylate (e.g., SR295, available from Sartomer Company, Inc. (West Chester, Pa.)), ethoxylated pentaerythritol tetraacrylate (e.g., SR494, Sartomer Company, Inc.), and dipentaerythritol pentaacrylate (e.g., Photomer 4399, Cognis Corp., and SR399, Sartomer Company, Inc.); isocyanurate polyacrylates formed by reacting an appropriate functional isocyanurate with an acrylic acid or acryloyl chloride, such as tris-(2-hydroxyethyl) isocyanurate triacrylate (e.g., SR368, Sartomer Company, Inc.) and tris-(2-hydroxyethyl) isocyanurate diacrylate; alcohol polyacrylates with and without alkoxylation such as tricyclodecane dimethanol diacrylate (e.g., CD406, Sartomer Company, Inc.) and ethoxylated polyethylene glycol diacrylate with ethoxylation being 2 or greater, preferably ranging from about 2 to 30; epoxy acrylates formed by adding acrylate to bisphenol A diglycidylether and the like (e.g., Photomer 3016, Cognis Corp.); and single and multi-ring cyclic aromatic or non-aromatic polyacrylates such as dicyclopentadiene diacrylate and (dicyclopentane diacrylate.

The activator layer coating composition may also contain a polymerization initiator that is suitable to cause polymerization (i.e., curing) of the binder composition after its application to the facestock. For ultraviolet radiation curing, the initiator includes at least one photoinitiator. Suitable photoinitiators include 1-hydroxycyclohexylphenyl ketone (e.g., Irgacure 184 available from Ciba Specialty Chemical (Hawthorne, N.Y.), (2,6-dimethoxybenzoyl)-2,4,4-trimethylpentyl phosphine oxide (e.g., commercial blends Irgacure 1800, 1850, and 1700 available from Ciba Specialty Chemical), 2,2i-dimethoxyl-2-phenyl acetophenone (e.g., Irgacure 651, available from Ciba Specialty Chemical), bis(2,4,6-trimethyl benzoyl)phenyl-phosphine oxide (Irgacure 819), (2,4,6-trimethylbenzoyl)diphenyl phosphine oxide (Lucerin TPO, available from BASF (Munich, Germany)), ethoxy (2,4,6-trimethylbenzoyl)phenyl phosphine oxide (Lucerin TPO-L from BASF), and combinations thereof. A particularly useful photoinitator is Irgacure 500, commercially available from Ciba Specialty Chemical, which is a 1:1 blend of Irgacure 184 and benzophenone.

In one embodiment, the composition used to form the activating layer is coated onto the polymer facestock. The film facestocks may be monolayer or multilayer constructions. The multilayer constructions may be coextruded or laminated.

The activating layer can be formed on the facestocks in various manners, for instance by means of engraving coating (e.g., direct gravure, reverse gravure, etc.), slot die, off-set coating, roll coating, curtain coating, or a casting process. The choice for a certain production method depends on the raw material characteristics and the desired thickness of the activating layer.

Drying of a water or diluent based system can be done by the usual thermal drying techniques, by means of microwaves or by infrared drying. Solvent-less systems can be cured thermally, by means of UV curing or Electron Beam curing.

Alternatively, the activating layer can be extruded onto the polymer facestock. In yet another embodiment, the facestock and the activating layers can be formed by coextrusion. In a further embodiment, the activating layer can be formed by sputtering or depositing a transition metal onto a surface of the facestock. For example, a copper sputtered transparent solar control film such as available from CP Films Inc. of Martinsville, Va. under the designation 15396A may be used in the labels of the invention where the copper is the activating agent.

Release Liner The release liner 18 that can be used in the construction of the second embodiment, illustrated in FIGS. 5a and 5b, may consist of any two-sided release. That is, both surfaces of the release liner are low surface energy surfaces. Release surface 17a is in contact with anaerobic adhesive 16 and release surface 17b is in contact with activating layer 12. In general, release surface 17a has different release properties than those of release surface 17b, with release surface 17a having the higher release properties.

The following example illustrates a composition containing an activating agent and a binder that is useful in forming the activating layer used in this invention, and its preparation. This example is illustrative only and not intended to be limiting in scope.

### Example 1

An activating layer coating composition is prepared by mixing together the binder ingredients: 20% by weight (based on the total weight of the binder) propoxylated trimethylol propane triacrylate monomer (Sartomer SR492), 50% by weight propoxylated neopentyl glycol diacrylate (Sartomer SR9003), and 30% by weight aliphatic difunctional polyether urethane acrylate oligomer (Bomar Specialties BR344). To the binder mixture is added an equal amount by weight of an activator composition of copper salt in acetone (7649 Primer N from Loctite). Photoinitiator (Irgacure 500 from Ciba Specialties), in an amount of 3 parts by weight (based on the total weight of the binder), is then added to the coating composition.

The coating composition is applied to the polyester surface of a biaxially oriented polypropylene (BOPP) film that has been coated in one surface with a polyester adhesion promoting layer, and the solvent is evaporated. The resulting coating is cured under a nitrogen atmosphere by passing the coated film under a Fusion H600 bulb at 100 fpm.

### Examples 24

Three activating layer coating compositions are prepared by mixing RotoStar 801-103 pigment (containing a UV monomer) and Ciba Irgacure 500 photoinitiator into Sartomer SR 903 binder (propoxylated neopentyl glycol diacrylate), in the amounts specified in the following table:

| | Example | | |
|---|---|---|---|
| | 2 | 3 | 4 |
| Sartomer SR 9003 | 97% | 93% | 88% |
| RotoStar 801-103 | 1% | 5% | 10% |
| Ciba Irgacure 500 | 2% | 2% | 2% |

These formulations are applied to the polyester surface of a biaxially oriented polypropylene film that has been coated on one surface with a polyester adhesion promoting layer using a #3 Meyer rod. The applied coating is cured using a Fusion bench top UV curing chamber under nitrogen with one fusion H600 bulb at 100 power and 100 fpm.

The labels of the present invention are useful for labeling of plastic, glass or metal containers or surfaces. The process generally is one wherein the labels (without adhesive) are provided as a stack in a label magazine. A rotating pallet removes adhesive from a rotating adhesive cylinder and applies adhesive to the activating layer on the top label in the stack. The label is then transferred to a label transfer drum, on which it is held by means such as vacuum suction and/or grippers. From the transfer drum, the label is applied on its adhesive side to the container. In one embodiment, the adhesive is normally applied to the label at ambient temperature, namely, from about 20 to 30° C.

To illustrate the application of the labels of the present invention to substrates such as glass substrates, an anaerobic adhesive comprising 100 parts Loctite Speedbonder 326, 100 parts by weight of Bomar Specialties BR-116 methacrylated urethane, 15 parts Sartomer CN9101 allyl oligomer is applied to the lower (exposed) surface of the activating layer of the labels prepared in Examples 2-4, and the labels are then applied to polyethylene coated beer bottles with the adhesive side of the label contacting the surface of the polyethylene coated beer bottle. The labels are allowed to age for 24 hours and subsequent analysis shows that in all of the examples, the adhesive cures well indicating that the activating agent can be utilized in amounts as low as 1% as supplied, and the activating agent provides a transparent and curable activating layer.

While the invention has been explained in relation to its various embodiments, it is to be understood that various modifications thereof will become apparent to those skilled in the art upon reading the specification. Therefore, it is to be understood that the invention disclosed herein is intended to cover such modifications as fall within the scope of the appended claims.

1. A label comprising:
(a) a polymer facestock having an upper surface and a lower surface,
(b) an activating layer having an upper surface and a lower surface wherein the upper surface of the activating layer underlies the facestock, and the activating layer comprises at least one activating agent for anaerobic curing.

2. The label of 1 wherein the activating layer comprises a binder and at least one activating agent.

3. The label of claim 1 wherein the activating agent comprises a transition metal.

4. The label of claim 3 wherein the activating agent is selected from copper, iron, manganese, cobalt, vanadium, and salts and complexes thereof.

5. The label of claim 1 wherein the activating agent comprises an organo-copper compound.

6. The label of claim 1 further comprising an anaerobic adhesive layer in contact with the lower surface of the activating layer.

7. The label of claim 2 wherein the binder is derived from a film forming monomer, oligomer, polymer or combination thereof.

8. A label comprising:
(a) a polymer facestock having an upper surface and a lower surface,
(b) an anaerobic adhesive layer having an upper surface and a lower surface wherein the upper surface of the adhesive is in contact with the lower surface of the facestock,
(c) a release liner having an upper release surface and a lower release surface wherein the upper release surface of the release liner is in contact with the lower surface of the anaerobic adhesive, and
(d) an activating layer having an upper surface and a lower surface wherein the upper surface of the activating layer is in contact with the lower release surface of the release liner, and the activating layer comprises at least one activating agent for anaerobic curing.

9. The label of 8 wherein the activating layer comprises a binder and at least one activating agent.

10. The label of claim 9 wherein the binder is derived from a film forming monomer, oligomer, polymer or combination thereof.

11. The label of claim 9 wherein the activating agent comprises a transition metal.

12. The label of claim 11 wherein the activating agent is selected from copper, iron, manganese, cobalt, vanadium, and salts and complexes thereof.

13. The label of claim 9 wherein the activating agent comprises an organo-copper compound.

14. A labeling process comprising providing a substrate surface and a label of claim 1, applying an anaerobic adhesive to the lower surface of the activating layer of the label, applying the side of the label to which the adhesive is applied to the substrate surface and allowing the adhesive to cure.

15. The labeling process of claim 14 wherein the substrate is glass, plastic or metal.

16. The labeling process of claim 14 wherein the substrate is a container.

17. The labeling process of claim 16 wherein the substrate is a glass container.

18. The labeling process of claim 16 wherein the substrate is a plastic container.

19. The labeling process of claim 1 wherein the activating agent comprises a transition metal, transition metal ions, a transition metal salt, transition metal complex, or combinations thereof.

20. The labeling process of claim 19 wherein the activating agent comprises an organo-copper compound.

21. The labeling process of claim 19 wherein the anaerobic adhesive comprises an acrylic-based resin.

22. The labeling process of claim 14 wherein the anaerobic adhesive comprises trimethylolpropane triacrylate.

23. The labeling process of claim 14 wherein the anaerobic adhesive comprises a photoinitiator.

24. A labeling process comprising providing a substrate surface and a label of claim 1, applying an anaerobic adhesive to at least a portion of the surface of the substrate, applying the lower surface of the activating layer of the label to the portion of the substrate surface to which the adhesive is applied, and allowing the adhesive to cure.

25. The labeling process of claim 24 wherein the substrate is glass, plastic or metal.

26. The labeling process of claim 24 wherein the substrate is a container.

27. The labeling process of claim 26 wherein the substrate is a glass container.

28. The labeling process of claim 26 wherein the substrate is a plastic container.

29. The labeling process of claim 24 wherein the activating agent comprises a transition metal, transition metal ions, a transition metal salt, transition metal complex, or blends thereof.

30. The labeling process of claim 29 wherein the activating agent comprises an organo-copper compound.

31. The labeling process of claim 29 wherein the anaerobic adhesive comprises an acrylic-based resin.

32. The labeling process of claim 24 wherein the anaerobic adhesive comprises trimethylolpropane triacrylate.

33. The labeling process of claim 29 wherein the anaerobic adhesive comprises trimethylolpropane triacrylate.

34. The labeling process of claim 24 wherein the anaerobic adhesive comprises a photoinitiator
